(19) United States
(12) Patent Application Publication
(10) Pub. No.: US 2019/0184848 A1
(43) Pub. Date: Jun. 20, 2019

(54) METHOD AND APPARATUS FOR CONTROLLING TORQUE ASSIST TIME OF MILD HYBRID ELECTRIC VEHICLE

(71) Applicants: HYUNDAI MOTOR COMPANY, Seoul (KR); KIA MOTORS CORPORATION, Seoul (KR)

(72) Inventor: Hwa Yong JANG, Hwaseong-si (KR)

(73) Assignees: HYUNDAI MOTOR COMPANY, Seoul (KR); KIA MOTORS CORPORATION, Seoul (FR)

(21) Appl. No.: 16/016,413

(22) Filed: Jun. 22, 2018

(30) Foreign Application Priority Data
Dec. 15, 2017 (KR) 10-2017-0173618

(51) Int. Cl. B60L 15/20; B60W 20/13; B60L 11/18

(52) U.S. Cl. CPC B60L 15/2045; B60W 20/13; B60L 11/1814; B60W 2510/244; B60L 2240/36; B60W 2550/12; B60W 2710/083; B60W 2710/305; B60L 2210/10; B60W 2530/00

(57) ABSTRACT

A method for controlling MHSG torque assist time of a mild hybrid electric vehicle includes detecting charge amount of a first battery, detecting indoor and outdoor temperature of the vehicle, expecting the MHSG torque assist time based on the outdoor temperature of the vehicle if the charge amount of the first battery exceeds a minimum charge amount, expecting an operation time of an air conditioner based on a data base of the air conditioner operating manners of a driver and a difference between the indoor and outdoor temperature of the vehicle, operating the MHSG to convert electricity from the first battery to the second battery, generating the MHSG to make the charge amount of the first battery to be maximum when the MHSG torque assist time is reached, and making the charge amount of the first battery to be maximum when the first battery becomes discharged.

### CROSS-REFERENCE TO RELATED APPLICATION

This application is based on and claims the benefit of priority to Korean Patent Application No. 10-2017-00173618 filed on Dec. 15, 2017 in the Korean Intellectual Property Office, the entire contents of which are incorporated herein by reference.

### TECHNICAL FIELD

The present disclosure relates to a method and an apparatus for controlling MHSG torque assist time of mild hybrid electric vehicle. More particularly, the present disclosure relates to a method and an apparatus for controlling MHSG torque assist time of mild hybrid electric vehicle in which an operation time of an air conditioner of the mild hybrid vehicle is expected and accordingly, the torque assist time of the mild hybrid electric vehicle is controlled.

### BACKGROUND

A hybrid electric vehicle is generally known as using its power source from an internal combustion engine and a battery together. The hybrid electric vehicle efficiently combines torque of the internal combustion engine and torque of a motor.

The hybrid electric vehicle may be divided into a hard type and a mild type according to a power sharing ratio between the engine and the motor. In case of the mild type of hybrid electric vehicle (hereinafter referred to as a mild hybrid electric vehicle), a mild hybrid starter & generator (MHSG) configured to start the engine or generate electricity according to an output of the engine is used instead of an alternator. In the case of the hard type of hybrid electric vehicle, a driving motor for generating driving torque is used in addition to an integrated starter & generator (ISG) configured to start the engine or generate electricity.

The mild hybrid electric vehicle may assist an engine torque according to a driving state of the vehicle by using the MHSG and may charge a battery (e.g., 48V battery) through a regenerative braking. Accordingly, fuel efficiency of the mild hybrid electric vehicle may be improved.

Further, the vehicle in which the mild hybrid electric vehicle is applied has to have high fuel efficiency and improved air conditioning function during summer or when operation of the air conditioner is required. Rather than the fuel efficiency, the vehicle in which the mild hybrid electric vehicle is applied is necessary to maintain indoor air to be comfortable so that a driver does not feel discomfort. To achieve this, when the MHSG is used to provide a torque assist for satisfying the torque required by a driver, the MHSG generates electricity to charge a 48V battery and converts the electricity to a 12V battery through an LDC at a time that charge amount (SOC) of the 48V battery is small due to the air conditioner being required to operate. However, electricity conversion efficiency becomes low such that consumption target value of the 12V battery of vehicle electrical components may not be matched.

The above information disclosed in this Background section is only for enhancement of understanding of the background of the disclosure and therefore it may contain information that does not form the prior art that is already known in this country to a person of ordinary skill in the art.

### SUMMARY

Accordingly, the present disclosure has been made in an effort to provide a method and an apparatus for controlling air conditioning in which operation requiring time is expected according to outdoor temperature, shortage of a battery power is prevented according to setting torque assist time of the MHSG to maintain the vehicle indoor temperature to be comfortable.

A method for controlling MHSG torque assist time of a mild hybrid electric vehicle including a mild hybrid starter generator (MHSG) according to an exemplary embodiment of the present disclosure includes detecting charge amount of a first battery, detecting indoor and outdoor temperature of the vehicle, expecting the MHSG torque assist time based on the outdoor temperature of the vehicle when the charge amount of the first battery exceeds a minimum charge amount, expecting an operation time of an air conditioner based on a data base of the air conditioner operating manners of a driver and a difference between the indoor and outdoor temperature of the vehicle, operating the MHSG to convert electricity from the first battery to the second battery, generating the MHSG to make the charge amount of the first battery to be maximum when the MHSG torque assist time is reached, and making the charge amount of the first battery to be maximum when the first battery becomes discharged, wherein the MHSG torque assist time is set to be a time at which the charge amount of the first battery becomes low to a first reference charge amount when the outdoor temperature of the vehicle is below a first reference temperature, the MHSG torque assist time is set to be a time at which the charge amount of the first battery becomes low to a second reference charge amount when the outdoor temperature of the vehicle exceeds the first reference temperature and is below a second reference temperature, and the MHSG torque assist time is set to be a time at which the charge amount of the first battery becomes low to a third reference charge amount when the outdoor temperature of the vehicle exceeds the second reference temperature.

The first reference temperature may be lower than the second reference temperature.

The first reference charge amount may be greater than the second reference charge amount, and the second reference charge amount may be greater than the third reference charge amount.

The first battery may be a 48V battery, and the second battery may be a 12V battery.

In the operating the MHSG to convert electricity from the first battery to the second battery, electricity generated from the MHSG may be converted to the second battery through a low DC-DC (LDC) converter, thereby maintaining the charge amount of the second battery to be maximum.

The MHSG torque assist time may be set to be former than an operating time of the air conditioner when the outdoor temperature of the vehicle is below the first reference temperature, and the MHSG torque assist time may be set to be later than an operating time of the air conditioner when the outdoor temperature of the vehicle exceeds the second reference temperature.

An apparatus for controlling MHSG torque assist time of a mild hybrid electric vehicle including a mild hybrid starter generator (MHSG) according to an exemplary embodiment of the present disclosure includes a first battery charge amount detecting sensor detecting the charge amount of a first battery, an indoor temperature sensor detecting the indoor temperature of a vehicle, an outdoor temperature sensor detecting the outdoor temperature of the vehicle, and a controller expecting the MHSG torque assist time based on the outdoor temperature of the vehicle and an operation time based on a data base of air conditioner operating manners of a driver and a difference between the indoor and outdoor temperature of the vehicle, wherein the controller generates the MHSG to make the charge amount of the first battery to be maximum when the MHSG torque assist time is reached.

The MHSG torque assist time may be set to be a time at which the charge amount of the first battery becomes low to a first reference charge amount when the outdoor temperature of the vehicle is below a first reference temperature, the MHSG torque assist time may be set to be a time at which the charge amount of the first battery becomes low to a second reference charge amount when the outdoor temperature of the vehicle exceeds the first reference temperature and is below a second reference temperature, and the MHSG torque assist time may be set to be a time at which the charge amount of the first battery becomes low to a third reference charge amount when the outdoor temperature of the vehicle exceeds the second reference temperature.

The first reference temperature may be lower than the second reference temperature.

The first reference charge amount may be greater than the second reference charge amount, and the second reference charge amount may be greater than the third reference charge amount.

The first battery may be a 48V battery, and the second battery may be a 12V battery.

The controller may convert electricity generated from the MHSG to the second battery through a low DC-DC (LDC) converter, thereby maintaining the charge amount of the second battery to be maximum.

The MHSG torque assist time may be set to be former than an operating time of the air conditioner when the outdoor temperature of the vehicle is below the first reference temperature, and the MHSG torque assist time may be set to be later than an operating time of the air conditioner when the outdoor temperature of the vehicle exceeds the second reference temperature.

As explained above, according to an exemplary embodiment of the present disclosure, operation requiring time is expected according to outdoor temperature and MHSG torque assist time is set, thereby preventing shortage of a battery power and maintaining the vehicle indoor temperature to be comfortable.

### BRIEF DESCRIPTION OF THE DRAWINGS

FIG. 1 is a block diagram of a mild hybrid electric vehicle according to an exemplary embodiment of the present disclosure.

FIG. 2 is a flowchart of a method for controlling MHSG torque assist time of mild hybrid electric vehicle according to an exemplary embodiment of the present disclosure.

FIG. 3 is a block diagram of an apparatus for controlling MHSG torque assist time of a mild hybrid electric vehicle according to an exemplary embodiment of the present disclosure.

FIG. 4 is a graph of MHSG torque assist possible section for explaining the method for controlling MHSG torque assist time of mild hybrid electric vehicle according to an exemplary embodiment of the present disclosure.

FIGS. 5A to 5C are illustrative drawings of charge amount of a first battery for explaining the method for controlling MHSG torque assist time of mild hybrid electric vehicle according to an exemplary embodiment of the present disclosure.

### DETAILED DESCRIPTION

In the following detailed description, the present disclosure will be described more fully with reference to the accompanying drawings, in which exemplary embodiments of the invention are shown. However, the present disclosure is not limited the exemplary embodiments which are described herein, and may be modified in various different ways.

Parts which are not related with the description are omitted for clearly describing the exemplary embodiment of the present disclosure, and like reference numerals refer to like or similar elements throughout the specification.

Since each component in the drawings is arbitrarily illustrated for easy description, the present disclosure is not particularly limited to the components illustrated in the drawings.

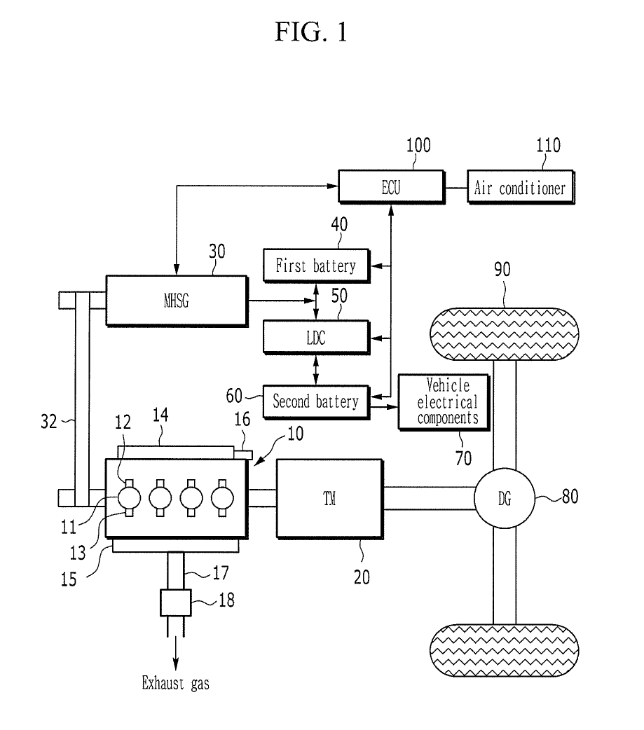

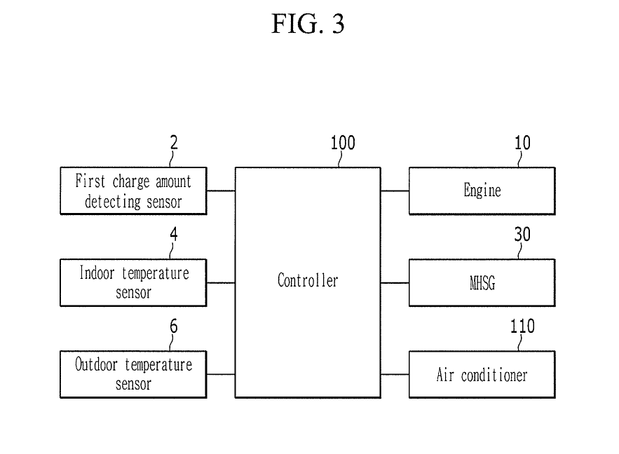

Hereinafter, referring to FIG. 1 and FIG. 3, an apparatus for controlling MHSG torque assist time of mild hybrid electric vehicle according to an exemplary embodiment of the present disclosure will be explained.

FIG. 1 is a block diagram of a mild hybrid electric vehicle according to an exemplary embodiment of the present disclosure, and FIG. 3 is a block diagram of an apparatus for controlling MHSG torque assist time of a mild hybrid electric vehicle according to an exemplary embodiment of the present disclosure.

As shown in FIG. 1, a mild hybrid electric vehicle according to an exemplary embodiment of the present disclosure includes an engine 10, a transmission 20, an MHSG (mild hybrid starter & generator) 30, a first battery 40, a differential gear device 80 and a wheel 90.

The engine 10 combusts fuel and air to convert chemical energy to mechanical energy.

In connection with torque transmission of the mild hybrid electric vehicle, torque generated from the engine 10 is transmitted to an input shaft of the transmission 20, and torque output from an output shaft of the transmission 20 is transmitted to an axle via the differential gear device 80. The axle rotates the wheel 90 such that the mild hybrid electric vehicle runs by the torque generated from the engine 10.

The MHSG 30 converts electric energy to mechanical energy, or mechanical energy to electric energy. That is, The MHSG 30 starts the engine 10 or generates electricity according to an output of the engine 10. In addition, the MHSG 30 may assist the torque of the engine 10. The torque of the engine 10 may be used as main torque and torque of the MHSG 30 may be used as auxiliary torque. The engine 10 and the MHSG 30 may be connected to each other through a belt 32.

The first battery 40 may supply electricity to the MHSG 30, and may be charged through electricity recovered through the MHSG 30 in a regenerative braking mode. The first battery 40 may be a 48V battery. The mild hybrid electric vehicle may further include a low voltage DC-DC converter (LDC) converting a voltage supplied from the first battery 40 into a low voltage, and a second battery 60 supplying a low voltage to electrical components 70 (e.g., a headlamp, an air conditioner, and a wiper). The second battery 60 may be a 12V battery.

The engine 10 may include a combustion chamber 11 into which fuel and air flow, an ignition device 12 igniting the fuel and the air flowing into the combustion chamber 11, and an injector 13 injecting the fuel. The engine 10 is connected to an intake manifold 14 so as to receive the air in the combustion chamber 11, and exhaust gas generated in a combustion process is gathered in an exhaust manifold 15 and is exhausted to the exterior of the engine 10. The injector 13 may be mounted in the combustion chamber 11 or the intake manifold 14. The engine 10 may include a plurality of combustion chambers 11.

A throttle valve 16 is disposed on an intake line supplying air to the intake manifold 14. Flow of air supplied to the intake manifold 14 is controlled according to an opening amount of the throttle valve 16.

The exhaust pipe 17 is connected to the exhaust manifold 15 to exhaust the exhaust gas to the exterior of the mild hybrid electric vehicle. A catalyst 18 may be mounted on the exhaust pipe 17 and remove hydrocarbons, carbon monoxide, and nitrogen oxide contained in the exhaust gas.

As shown in FIG. 3, an apparatus for controlling MHSG torque assist time of a mild hybrid electric vehicle according to an exemplary embodiment of the present disclosure includes a first battery charge amount detecting sensor 2, an indoor temperature sensor 4, an outdoor temperature sensor 6, and a controller 100.

The first charge amount detecting sensor 2 detects the charge amount of a first battery 40 and transmits the signal to the controller 100, and the indoor temperature sensor 4 and the outdoor temperature sensor 6 respectively detects the indoor temperature and the outdoor temperature of the vehicle and transmits the signal to the controller 100.

The controller 100 expects the MHSG torque assist time T1 based on the outdoor temperature of the vehicle and an operation time T2 based on a data base of air conditioner 110 operating manners of a driver and a difference between the indoor and outdoor temperature of the vehicle. Further, controller 100 controls the MHSG to make the charge amount of the first battery 40 to be maximum when the MHSG torque assist time T1 is reached.

The controller 100 may be implemented with one or more processors (e.g., a CPU, etc.) and an associated non-transitory memory storing software instructions executed by the one or more processors. The software instructions may include a series of commands for performing each step included in a method for controlling MHSG torque assist time of mild hybrid electric vehicle according to an exemplary embodiment of the present disclosure to be described below.

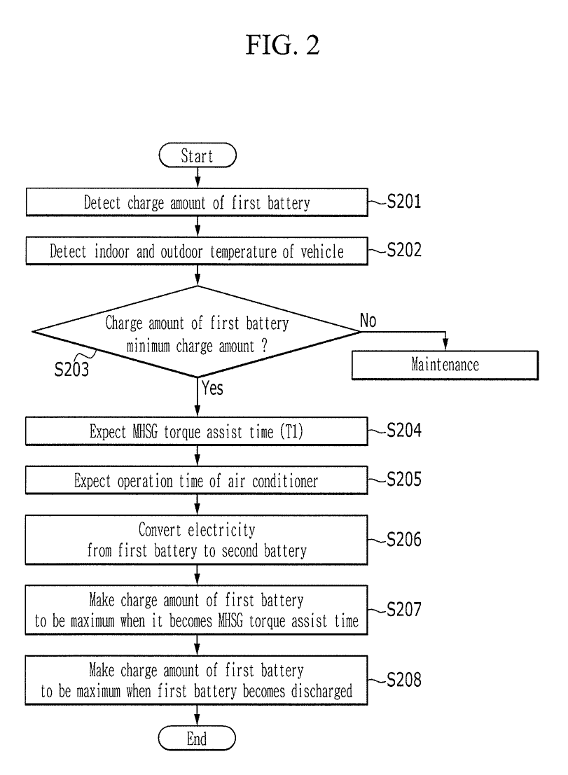

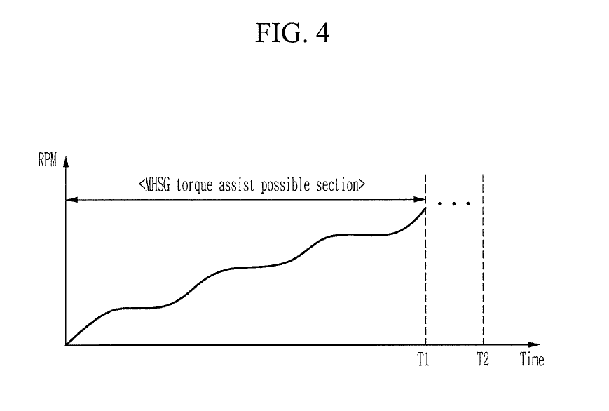

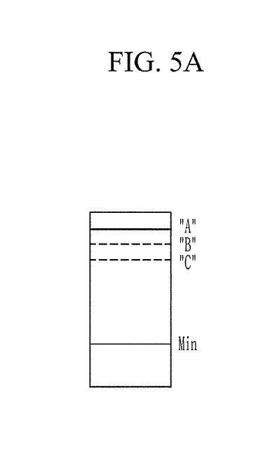

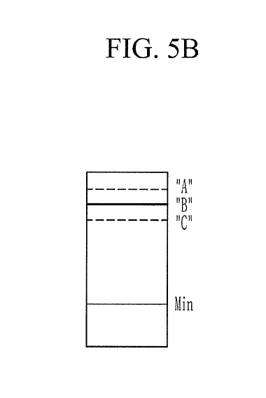

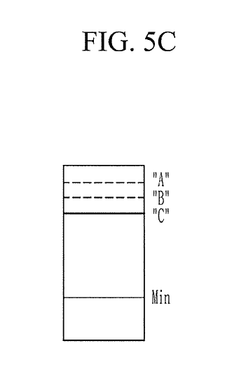

FIG. 2 is a flowchart of a method for controlling MHSG torque assist time of mild hybrid electric vehicle according to an exemplary embodiment of the present disclosure, FIG. 4 is a graph of MHSG torque assist possible section for explaining the method for controlling MHSG torque assist time of mild hybrid electric vehicle according to an exemplary embodiment of the present disclosure, and FIGS. 5A to 5C are illustrative drawings of charge amount of a first battery 40 for explaining the method for controlling MHSG torque assist time of mild hybrid electric vehicle according to an exemplary embodiment of the present disclosure.

Referring to FIG. 2, FIG. 4 and FIGS. 5A-5C, charge amount of a first battery 40 is detected by a first battery charge amount detecting sensor 2 (S201), and an indoor temperature and an outdoor temperature of the vehicle are detected (S202).

Then, whether the charge amount of the first battery 40 exceeds a minimum charge amount (S203) is determined. At this time, the minimum charge amount may be set by a person of ordinary skill in the art through an experiment.

The MHSG torque assist time T1 is expected based on the outdoor temperature of the vehicle if the charge amount of the first battery 40 exceeds the minimum charge amount (S204).

The MHSG torque assist time T1 may be set to be a time at which the charge amount of the first battery 40 becomes low to a first reference charge amount A if the outdoor temperature of the vehicle is below a first reference temperature t1. The MHSG torque assist time T1 may be set to be a time at which the charge amount of the first battery 40 becomes low to a second reference charge amount B if the outdoor temperature of the vehicle exceeds the first reference temperature t1 and is below a second reference temperature t2. The MHSG torque assist time T1 may be set to be a time at which the charge amount of the first battery 40 becomes low to a third reference charge amount C if the outdoor temperature of the vehicle exceeds the second reference temperature t2. At this time, the first reference temperature t1 is lower than the second reference temperature t2, and the first reference charge amount A is greater than the second reference charge amount B, and the second reference charge amount B is greater than the third reference charge amount C. Here, the first reference temperature t1, the second reference temperature t2, the first reference charge amount A, the second reference charge amount B, and the third reference charge amount C may be set by a person of ordinary skill in the art through an experiment.

Further, the first battery 40 may be a 48V battery, and the second battery 60 may be a 12V battery.

Then, an operation time T2 of an air conditioner 110 is expected based on a data base of the air conditioner operating manners of a driver and a difference between the indoor and outdoor temperature of the vehicle (S205). Times at which a driver of the vehicle operates an air conditioner 110 when a difference between the indoor temperature and the outdoor temperature of the vehicle becomes a certain degree are repeatedly obtained, which are stored in a data base. Accordingly, the operation time T2 of the air conditioner 110 is expected based on the operation time of the air conditioner 110 stored in the data base and the difference between the indoor temperature and the outdoor temperature of the vehicle.

Then, the MHSG operates to convert electricity from the first battery 40 to the second battery 60 (S206). At this time, electricity generated from the MHSG is converted to the second battery 60 through a low DC-DC (LDC) converter 50, thereby maintaining the charge amount of the second battery 60 to be maximum.

Meanwhile, the MHSG torque assist time T1 may be set to be former than an operating time T2 of the air conditioner 110 if the outdoor temperature of the vehicle is below the first reference temperature t1, and the MHSG torque assist time T1 may be set to be later than an operating time T2 of the air conditioner 110 if the outdoor temperature of the vehicle exceeds the second reference temperature t2.

Referring to FIG. 4, the MHSG torque assist possible section is up to the MHSG torque assist time T1, and the MHSG torque assist time T1 may be set to be former than the expected operating time T2 of the air conditioner 110 when the outdoor temperature of the vehicle is below the first reference temperature t1, that is, the indoor temperature of the vehicle is relatively higher than the outdoor temperature of the vehicle. Further, the MHSG torque assist time T1 may be set to be later than the expected operating time T2 of the air conditioner 110 when the outdoor temperature of the vehicle exceeds the second reference temperature t2, that is, the indoor temperature of the vehicle is relatively lower than the outdoor temperature of the vehicle.

Then, the MHSG generates electricity to make the charge amount of the first battery 40 to be maximum when the MHSG torque assist time T1 is reached (S207).

Referring to FIGS. 5A to 5C, the MHSG torque assist time T1 is set to be a time at which the charge amount of the first battery 40 becomes low to a first reference charge amount A if the outdoor temperature of the vehicle is below a first reference temperature t1 (FIG. 5A), the MHSG torque assist time T1 is set to be a time at which the charge amount of the first battery 40 becomes low to a second reference charge amount B if the outdoor temperature of the vehicle exceeds the first reference temperature t1 and is below a second reference temperature t2 (FIG. 5B), and the MHSG torque assist time T1 is set to be a time at which the charge amount of the first battery 40 becomes low to a third reference charge amount C if the outdoor temperature of the vehicle exceeds the second reference temperature t2 (FIG. 5C).

Then, in a state that the charge amount of the first battery 40 is maximum, the MHSG 30 generates electricity again to make the charge amount of the first battery 40 to be maximum when the charge amount of the first battery 40 is respectively reduced to the first reference charge amount A, the second reference charge amount B and the third reference charge amount B.

As explained above, according to an exemplary embodiment of the present disclosure, operation requiring time is expected according to outdoor temperature, shortage of a battery power is prevented according to setting torque assist time of the MHSG to maintain the vehicle indoor temperature to be comfortable.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling MHSG torque assist time of a mild hybrid electric vehicle including a mild hybrid starter generator (MHSG), comprising steps of:
detecting charge amount of a first battery;
detecting indoor and outdoor temperature of a vehicle;
expecting the MHSG torque assist time based on the outdoor temperature of the vehicle when the charge amount of the first battery exceeds a minimum charge amount;
expecting an operation time of an air conditioner based on a data base of the air conditioner operating manners of a driver and a difference between the indoor and outdoor temperature of the vehicle;
operating the MHSG to convert electricity from the first battery to the second battery;
generating the MHSG to make the charge amount of the first battery to be maximum when the MHSG torque assist time is reached; and
making the charge amount of the first battery to be maximum when the first battery becomes discharged.

2. The method for controlling MHSG torque assist time of a mild hybrid electric vehicle of claim 1, wherein:
the MHSG torque assist time is set to be a time at which the charge amount of the first battery becomes low to a first reference charge amount when the outdoor temperature of the vehicle is below a first reference temperature,
the MHSG torque assist time is set to be a time at which the charge amount of the first battery becomes low to a second reference charge amount when the outdoor temperature of the vehicle exceeds the first reference temperature and is below a second reference temperature, and
the MHSG torque assist time is set to be a time at which the charge amount of the first battery becomes low to a third reference charge amount when the outdoor temperature of the vehicle exceeds the second reference temperature.

3. The method for controlling MHSG torque assist time of a mild hybrid electric vehicle of claim 2, wherein:
the first reference temperature is lower than the second reference temperature.

4. The method for controlling MHSG torque assist time of a mild hybrid electric vehicle of claim 2, wherein:
the first reference charge amount is greater than the second reference charge amount, and
the second reference charge amount is greater than the third reference charge amount.

5. The method for controlling MHSG torque assist time of a mild hybrid electric vehicle of claim 2, wherein:
the first battery is a 48V battery, and the second battery is a 12V battery.

6. The method for controlling MHSG torque assist time of a mild hybrid electric vehicle of claim 2, wherein:
in the step of operating the MHSG to convert electricity from the first battery to the second battery, electricity generated from the MHSG is converted to the second battery through a low DC-DC (LDC) converter, thereby maintaining the charge amount of the second battery to be maximum.

7. The method for controlling MHSG torque assist time of a mild hybrid electric vehicle of claim 2, wherein:
the MHSG torque assist time is set to be former than an operating time of the air conditioner when the outdoor temperature of the vehicle is below the first reference temperature, and
the MHSG torque assist time is set to be later than an operating time of the air conditioner when the outdoor temperature of the vehicle exceeds the second reference temperature.

8. An apparatus for controlling MHSG torque assist time of a mild hybrid electric vehicle including a mild hybrid starter generator (MHSG), comprising:
a first battery charge amount detecting sensor detecting a charge amount of a first battery;
an indoor temperature sensor detecting an indoor temperature of a vehicle;
an outdoor temperature sensor detecting an outdoor temperature of the vehicle; and
a controller configured to expect the MHSG torque assist time based on the outdoor temperature of the vehicle and an operation time based on a data base of air conditioner operating manners of a driver and a difference between the indoor and outdoor temperature of the vehicle,
wherein the controller is further configured to generate the MHSG to make the charge amount of the first battery to be maximum when the MHSG torque assist time is reached.

9. The apparatus for controlling MHSG torque assist time of a mild hybrid electric vehicle of claim 8, wherein:
the MHSG torque assist time is set to be a time at which the charge amount of the first battery becomes low to a first reference charge amount when the outdoor temperature of the vehicle is below a first reference temperature,
the MHSG torque assist time is set to be a time at which the charge amount of the first battery becomes low to a second reference charge amount when the outdoor temperature of the vehicle exceeds the first reference temperature and is below a second reference temperature, and
the MHSG torque assist time is set to be a time at which the charge amount of the first battery becomes low to a third reference charge amount when the outdoor temperature of the vehicle exceeds the second reference temperature.

10. The apparatus for controlling MHSG torque assist time of a mild hybrid electric vehicle of claim 9, wherein:
the first reference temperature is lower than the second reference temperature.

11. The apparatus for controlling MHSG torque assist time of a mild hybrid electric vehicle of claim 9, wherein:
the first reference charge amount is greater than the second reference charge amount, and
the second reference charge amount is greater than the third reference charge amount.

12. The apparatus for controlling MHSG torque assist time of a mild hybrid electric vehicle of claim 9, wherein:
the first battery is a 48V battery, and the second battery is a 12V battery.

13. The apparatus for controlling MHSG torque assist time of a mild hybrid electric vehicle of claim 9, wherein:
the controller converts electricity generated from the MHSG to the second battery through a low DC-DC (LDC) converter, thereby maintaining the charge amount of the second battery to be maximum.

14. The apparatus for controlling MHSG torque assist time of a mild hybrid electric vehicle of claim 9, wherein:
the MHSG torque assist time is set to be former than an operating time of the air conditioner when the outdoor temperature of the vehicle is below the first reference temperature, and
the MHSG torque assist time is set to be later than an operating time of the air conditioner when the outdoor temperature of the vehicle exceeds the second reference temperature.
